(19) United States
(12) Patent Application Publication
(10) Pub. No.: US 2010/0188859 A1
(43) Pub. Date: Jul. 29, 2010

(54) REFLECTING ASSEMBLY OF A SIMULATED FIREPLACE

(75) Inventor: Xinjun ZHAO, Fujian Province (CN)

Correspondence Address: YH Chan, 42 Pin Oaks Drive, Phoenixville, PA, 19460, US

(73) Assignee: ALLE ELECTRONICS CO., LTD. FUJIAN, FUJIAN PROVINCE (CN)

(21) Appl. No.: 12/538,174

(22) Filed: Aug. 10, 2009

(30) Foreign Application Priority Data
Jan. 23, 2009 (CN) 200920136578.4

(51) Int. Cl. F21V 7/10; F21S 10/04

(52) U.S. Cl. 362/346

(57) ABSTRACT

The invention presents a reflecting assembly of a simulated fireplace which comprises a shaft and a reflecting strip arranged with a plurality of reflectors, wherein a plurality of through openings being configured on the reflecting strip along the length direction, and the shaft extending inside the through openings sequentially. With the above solutions, the reflecting assembly according to the present invention has an advantage in that the shaft could be a simple round rod without any openings on it. After the shaft goes through the through openings sequentially, each of the reflectors is simply twisted towards a certain direction so as to form the reflecting assembly. The present invention has the advantages over the prior art in that the fabrication is easier, and in that the reflecting strip could be replaced as required since it's detachable from the shaft.

### BACKGROUND OF THE INVENTION

The invention relates to a simulated fireplace, and more particularly to a reflecting assembly of a simulated fireplace.

Fireplaces are commonly used in hotels, at home and at any public sites as a decoration apparatus. A fireplace comprises a housing and a flame simulating apparatus disposed within the housing. The flame simulating apparatus comprises a light source, a reflecting assembly, a motor, a filter with a flame-shaped translucent area and an imaging screen. Being rotated by the motor, the reflecting assembly reflects the light coming from the light source to the filter. The light penetrating the flame-shaped translucent area of the filter is projected onto the imaging screen so as to form a simulated flame.

As shown in FIG. 1, a reflecting assembly of a traditional fireplace comprises a shaft and two reflecting strips that are winded together. A plurality of reflectors are arranged on each of the two reflecting strips along the length direction. An elongate opening is configured on the shaft along the length direction. The two winded reflecting strips are inserted in the elongate opening and are secured in the opening by pressing the two winded reflecting strips against the shaft and then screwing the shaft until the shaft becomes a spiral. Eventually the plurality of reflectors on each of the two reflecting strips are taken apart and twisted, so as to form the reflecting assembly. This type of reflecting assembly is hard to fabricate for it's inclined to bend, and once the shaft is screwed, restoration is impossible, which means, the reflecting strips are not replaceable.

### BRIEF SUMMARY OF THE INVENTION

The objective of the present invention is to provide a reflecting assembly of a simulated fireplace that is easy to fabricate and has a replaceable reflecting strip.

To achieve the above objective, the present invention has the technical solutions as follows: a reflecting assembly of a simulated fireplace comprising a shaft and a reflecting strip arranged with a plurality of reflectors, wherein a plurality of through openings are configured on the reflecting strip along the length direction, and the shaft extends inside the through openings sequentially.

The through openings are configured on the medial axis of the reflecting strip along the length direction.

The adjoining reflectors are connected by and only by the central portion other than the lateral ends.

With the above solutions, the reflecting assembly according to the present invention has an advantage in that the shaft could be a simple round rod without any openings on it. After the shaft goes through the through openings sequentially, each of the reflectors is simply twisted towards a certain direction so as to form the reflecting assembly. The present invention has the advantages over the prior art in that the fabrication is easier, the yield is better, and in that the reflecting strip could be replaced as required since it's detachable from the shaft.

### BRIEF DESCRIPTION OF THE DRAWINGS

FIG. 1 is a schematic view of the reflecting assembly of the existing simulated fireplace.

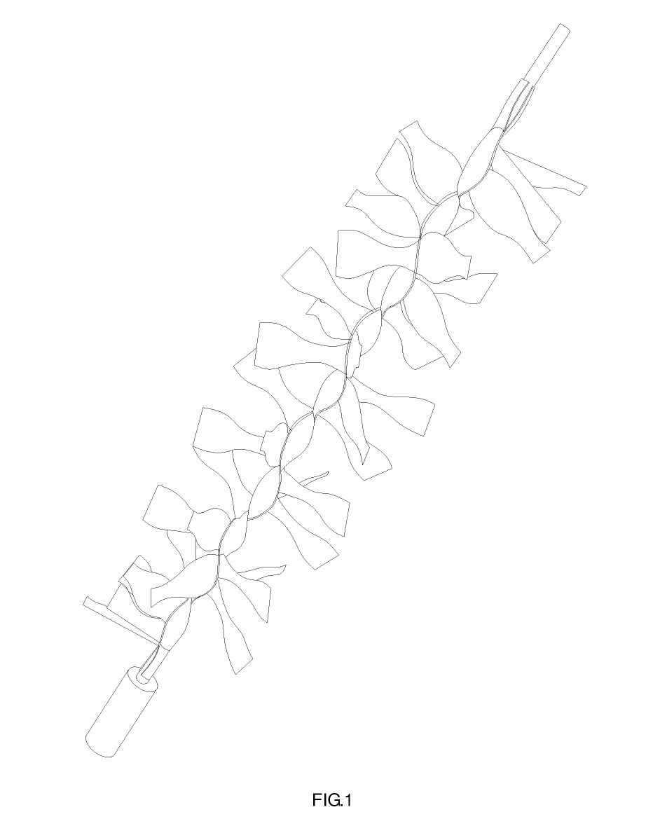

FIG. 2 is a schematic view of the present invention.

FIG. 3 is a schematic view of an unattached reflecting strip.

### DETAILED DESCRIPTION OF THE INVENTION

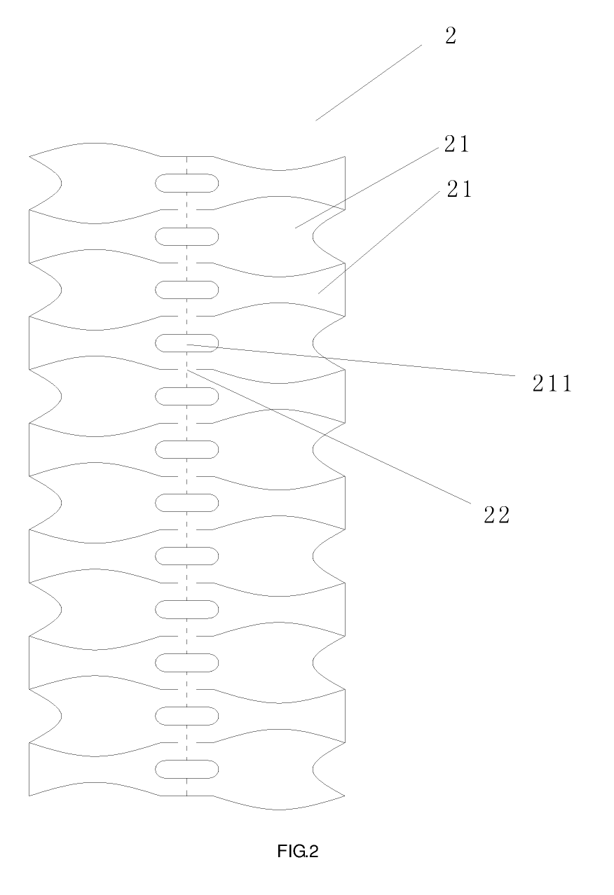

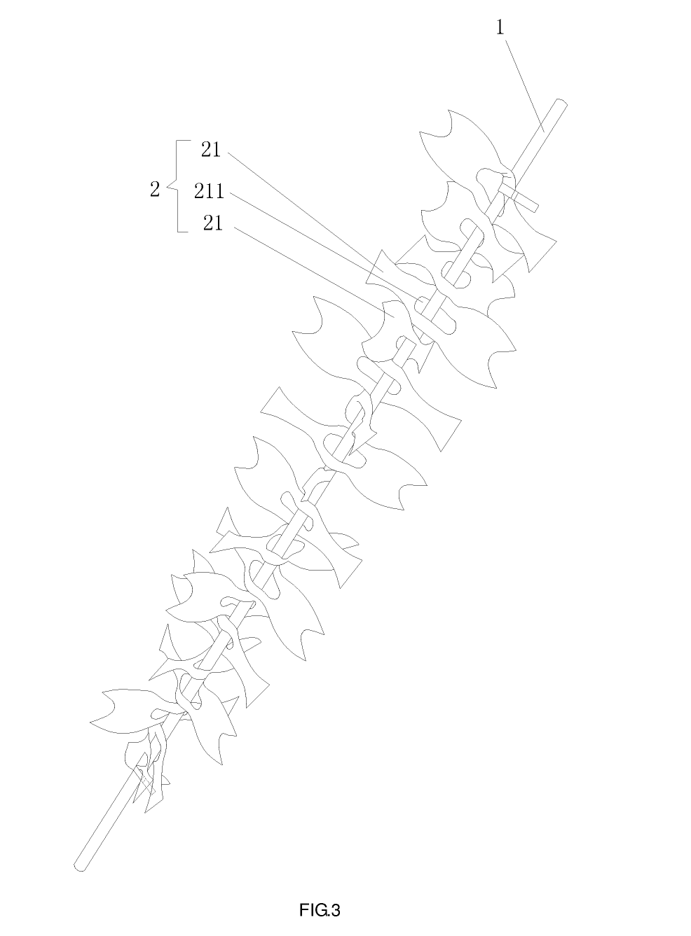

As shown in FIG. 2 and FIG. 3, a reflecting assembly of a simulated fireplace comprises a shaft 1 and a reflecting strip 2. A plurality of reflectors 21 are configured on the reflecting strip 2 along the length direction. The adjoining reflectors 21 are connected by and only by the connection area 22 in the central portion. But at the lateral ends, the adjoining reflectors 21 are unconnected. Through openings 211 are configured in the central portion of the reflectors 21. The through openings 211 are located on the medial axis of the reflecting strip 2 along the length direction sequentially. The reflecting strip 2 is pulled on the shaft 1 by putting the shaft 1 into the through openings sequentially. Then each of the reflectors 21 on the reflecting strip 2 is twisted towards a certain direction. The reflecting strip 2 may be fastened to the shaft 1 at two ends via a cord to prevent the reflecting strip 2 from falling off the shaft 1.

The reflecting assembly according to the present invention has an advantage in that the shaft could be a simple round rod without any openings on it. After the shaft goes through the through openings sequentially, each of the reflectors is simply twisted towards a certain direction so as to form the reflecting assembly. The present invention has the advantages over the prior art in that the fabrication is easier, and in that the reflecting strip could be replaced as required since it's detachable from the shaft.

The above embodiment is a preferred solution of the present invention. Any other solutions that are based on the claims of the present invention, and that are general variation or development of the present invention, are within the protection of the present invention.

I claim:

1. A reflecting assembly of a simulated fireplace comprising a shaft and a reflecting strip arranged with a plurality of reflectors, characterized in that a plurality of through openings are configured on the reflecting strip along the length direction, and the shaft goes through the through openings sequentially.

2. The reflecting assembly of a simulated fireplace as claimed by claim 1, characterized in that the through openings are configured on the medial axis of the reflecting strip along the length direction.

3. The reflecting assembly of a simulated fireplace as claimed by claim 1, characterized in that the adjoining reflectors are connected by and only by the central portion other than the lateral ends.

4. The reflecting assembly of a simulated fireplace as claimed by claim 3, characterized in that each of the reflectors is twisted.

5. The reflecting assembly of a simulated fireplace as claimed by claim 3, characterized in that the reflecting strip is fixed at two ends via a fixing part.
